(19) United States
(12) Patent Application Publication
(10) Pub. No.: US 2007/0119363 A1
(43) Pub. Date: May 31, 2007

(54) Hose apparatus wear indicator

(76) Inventors: Leven Vampre Neto, Sao Paulo - SP (BR); Bruno Ranieri Torchio, Sao Paulo - SP (BR)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/519,825

(22) Filed: Sep. 12, 2006

Related U.S. Application Data
(60) Provisional application No. 60/740,773, filed on Nov. 30, 2005.

(51) Int. Cl. G01D 21/00

(52) U.S. Cl. 116/208

(57) ABSTRACT

A hose having a reflective wear indicator is provided. The hose comprises an inner elastomeric layer, an optional reinforcement layer and a cover. A light-reflective wear indicator is located radially outward of the inner layer, and is preferably embedded within the outer hose cover. As the hose wears the light reflective wear indicator is exposed, making detection by a light source such as a flash light easy.

This application claims the benefit of U.S. provisional application No. 60/740,773, filed Nov. 30, 2005.

### TECHNICAL FILED

The disclosed invention is directed in general towards a hose, and more specifically to a hose for use in abrasive environments such as mining applications.

### BACKGROUND ART

Hoses used in harsh environments require routine visual inspection to ensure that the hose structural integrity is maintained. Visual inspection of hoses in low light environments is thus hampered by the lack of light. Thus it is desired to have a hose that has an external configuration which has a wear indicator to indicate that the hose needs to be replaced.

### BRIEF DESCRIPTION OF DRAWINGS

The invention will be described by way of example and with reference to the accompanying drawings in which:

FIG. 1 is a perspective view of the hose of the present invention;

FIG. 2 is a partial cross-sectional view of the hose of FIG. 1;

FIG. 3 is a partial cross-sectional view of the hose of FIG. 1 shown with an abrasion revealing one or more of the wear indicators;

FIG. 4 is a cross-sectional view of the hose of FIG. 1 showing the internal construction.

### DETAILED DESCRIPTION OF THE INVENTION

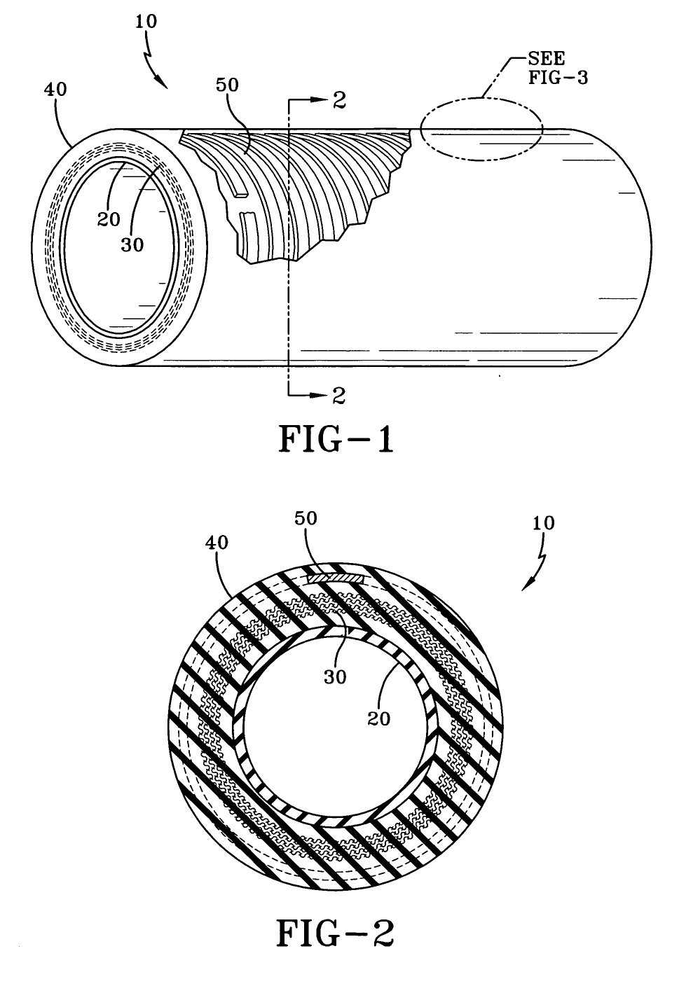

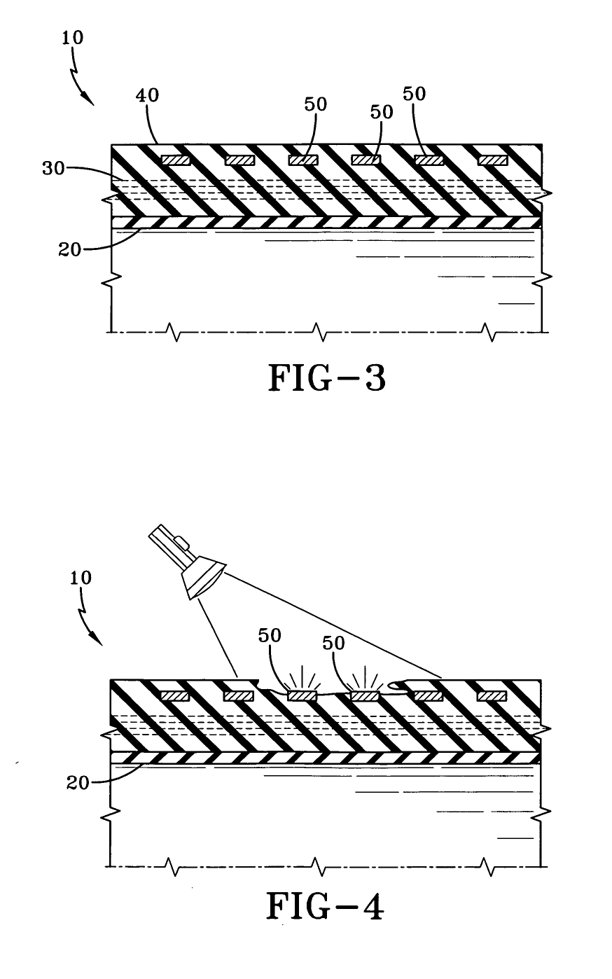

Illustrated in FIG. 1 is an overview of the hose 10 of the present invention. The hose 10 is typically a multi-layered laminate having an inner layer or tube 20 which is in direct contact with the material being conveyed through the hose. The inner layer 20 is typically comprised of rubber or an elastomeric material preferably comprised of an abrasion resistant material.

Hose 10 may optionally include a middle reinforcing layer 30. The middle reinforcing layer 30 may comprise braided steel wire, fabric reinforced material, or a metal reinforced fabric.

Hose 10 further comprises an outer cover 40. The outer cover may be comprised of a rubber or elastomeric material. Embedded within the outer cover 40 is a light reflective wear indicator. The wear indicator 50 may be embedded in a spiral or helix manner at a predetermined depth of the hose. The wear indicator 50 may also be located between the reinforcement layer 30 and cover 40. The wear indicator may comprise reflective tape such as for example, an aluminum hydroxide strip. Thus when the hose cover becomes worn, the light reflective strip is illuminated by lighting the hose, via a flashlight or other light source. Alternatively, a brightly colored or shiny strip may also be used, such as, but not limited to, neon, orange, bright green, silver, yellow, gold or other contrasting color.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention.

1. A hose having an inner rubber layer, a middle reinforcing layer and an outer cover, and a light reflective wear indicator embedded within the outer cover.

2. The hose of claim 1 wherein the wear indicator is reflective tape.

3. The hose of claim 1 wherein the wear indicator is helically wound.

4. The hose of claim 1 wherein the wear indicator is an aluminum hydroxide material.

5. A hose having an inner rubber layer and an outer cover, and a light reflective wear indicator located radially outward of the inner rubber layer.

6. The hose of claim 5 wherein the wear indicator is reflective tape.

7. The hose of claim 5 wherein the wear indicator is a aluminum hydroxide material.

8. The hose of claim 5 wherein the wear indicator is helically wound.
